(19) United States
(12) Patent Application Publication
(10) Pub. No.: US 2024/0108042 A1
(43) Pub. Date: Apr. 4, 2024

(54) COMPOSITIONS AND METHODS FOR ENHANCING SWEETNESS

(71) Applicant: PepsiCo, Inc., Purchase, NY (US)

(72) Inventors: Shawn ERICKSON, Leonia, NJ (US); Christophe GALOPIN, Rye Brook, NY (US)

(21) Appl. No.: 18/327,665

(22) Filed: Jun. 1, 2023

Related U.S. Application Data
(63) Continuation of application No. 16/488,897, filed on Aug. 26, 2019, now abandoned.
(60) Provisional application No. 62/463,888, filed on Feb. 27, 2017.

(51) Int. Cl. A23L 27/30; A23L 2/60; A23L 27/00

(52) U.S. Cl. CPC A23L 27/36; A23L 2/60; A23L 27/88; A23V 2002/00

(57) ABSTRACT

The present disclosure provides methods for enhancing sweetness of certain sweeteners using rebaudioside F. The application also provides compositions comprising rebaudioside F as a sweetness enhancer, such as beverages, a sweetener compositions, and beverage syrups.

### FIELD OF THE DISCLOSURE

The present disclosure provides methods for enhancing the sweetness of sweeteners. The present disclosure further provides compositions comprising a sweetener and a sweetness enhancer.

### BACKGROUND

Steviol glycosides, including the rebaudiosides, show promise as sweeteners suitable for reducing sugar content in foods and beverages. But while certain steviol glycosides, including particular rebaudiosides, offer sweetness and flavor profiles approaching those of their nutritive counterparts, most steviol glycosides do not fully replicate the taste of sugar and suffer from one or more of slow on-set or off-tastes including, for example, bitter, licorice, or lingering aftertastes.

### SUMMARY

The present disclosure provides a novel method of enhancing the sweetness of a sweetener. In particular embodiments, the method comprises adding an effective amount of rebaudioside F to a sweetener. In other embodiments, the present disclosure provides beverages, beverage syrups, and sweetener compositions comprising rebaudioside F and a sweetener.

In certain embodiments, the present disclosure provides a method of enhancing the sweetness of a sweetener. In certain embodiments, the method comprises combining the sweetener with an effective amount of rebaudioside F, wherein the sweetener is a nutritive or non-nutritive sweetener.

In certain embodiments, the sweetener is a nutritive or non-nutritive sweetener other than a steviol glycoside.

In certain embodiments, the sweetener is selected from the group consisting of high fructose corn syrup (HFCS), fructose, glucose, sucralose, aspartame, sucrose, and combinations thereof.

In certain embodiments, the effective amount of rebaudioside F ranges from about 20 ppm to about 150 ppm or from about 20 ppm to about 90 ppm.

In certain embodiments, the effective amount of rebaudioside F is about 30 ppm, about 60 ppm, or about 90 ppm.

In certain embodiments, combining the sweetener with the effective amount of rebaudioside F results in an increase in sweetness ranging from about 1% to about 100% relative to the sweetness of the sweetener in the absence of rebaudioside F.

In certain embodiments, the increase in sweetness is about 1%.

In certain embodiments, the increase in sweetness is about 100%.

In certain embodiments the effective amount of rebaudioside F ranges from about 20 ppm to about 150 ppm or from about 20 ppm to about 90 ppm.

In certain embodiments, the effective amount of rebaudioside F is about 30 ppm, about 60 ppm, or about 90 ppm.

In certain embodiments, the present disclosure provides a beverage comprising water, a sweetener, and an effective amount of rebaudioside F.

In certain embodiments, the sweetener is a nutritive or non-nutritive sweetener.

In certain embodiments, the sweetener is a nutritive or non-nutritive sweetener other than a steviol glycoside.

In certain embodiments, the effective amount of rebaudioside F ranges from about 20 ppm to about 150 ppm.

In certain embodiments, the effective amount of rebaudioside F is about 30 ppm, about 60 ppm, or about 90 ppm.

In certain embodiments, the beverage is a coffee drink, a cola drink, a tea drink, a juice drink, a dairy drink, a sports drink, a ready-to-drink drink, a fountain drink, a frozen drink, a frozen carbonated drink, a carbonated drink, an energy drink, or a flavored water drink.

In certain embodiments, the beverage further comprises at least one of caffeine, caramel and other colorants, artificial flavoring, natural flavoring, preservatives, antifoaming agents, gums, emulsifiers, tea solids, cloud components, minerals, antioxidants, and vitamins.

In certain embodiments, the present disclosure provides a sweetener composition comprising a sweetener and an effective amount of rebaudioside F.

In certain embodiments, the present disclosure provides a beverage syrup comprising water, a sweetener, and rebaudioside F at a concentration ranging from about 120 ppm to about 900 ppm.

In certain embodiments, the sweetener is a nutritive sweetener or a non-nutritive sweetener other than rebaudioside A.

In certain embodiments, the nutritive sweetener or non-nutritive sweetener is selected from the group consisting of high fructose corn syrup (HFCS), fructose, glucose, sucralose, aspartame, sucrose, and combinations thereof.

In certain embodiments, the rebaudioside F concentration ranges from about 120 ppm to about 600 ppm.

In certain embodiments, the rebaudioside F concentration is about 180 ppm, about 360 ppm, or about 540 ppm.

### BRIEF DESCRIPTION OF THE DRAWINGS

FIG. 1 depicts the chemical structure of rebaudioside F.

FIG. 2 depicts the structural similarities and differences between rebaudiosides A and F.

FIG. 3 depicts a flow chart for the isolation of rebaudioside F as shown in Example 3.

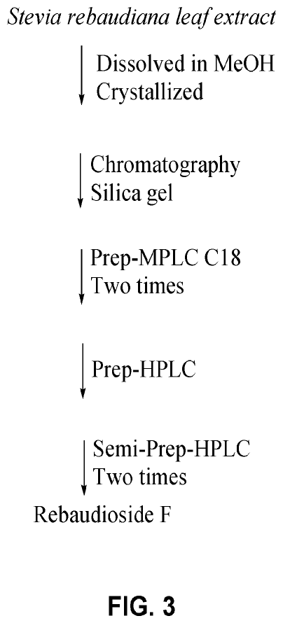

FIG. 4 depicts a flow chart for the isolation of rebaudioside F as shown in Example 4.

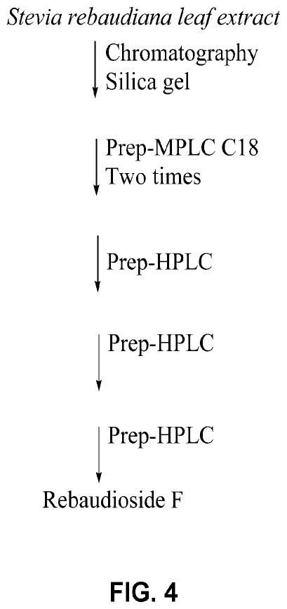

### DETAILED DESCRIPTION

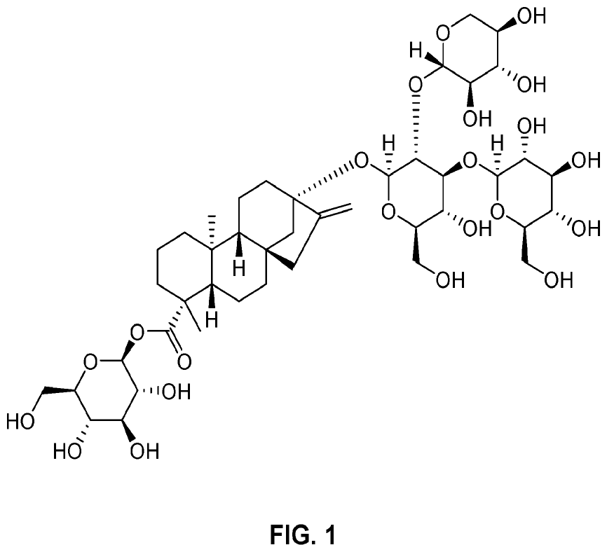

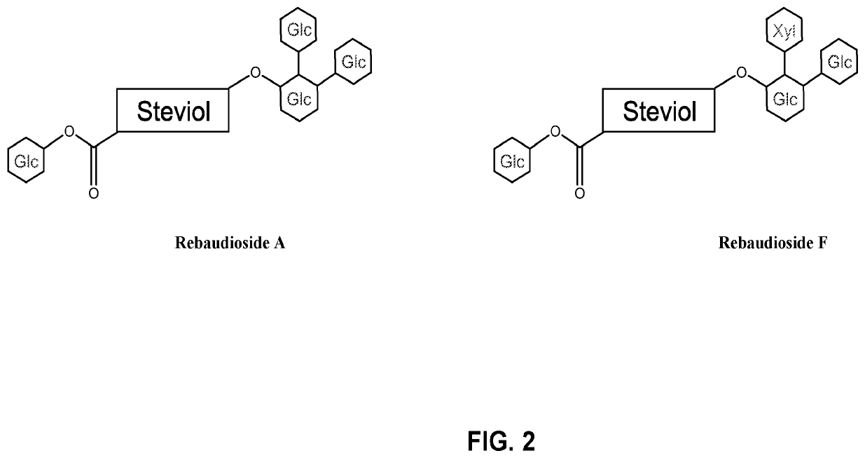

Rebaudioside F is a naturally occurring steviol glycoside whose structure is shown in FIG. 1. Rebaudioside F is structurally similar to rebaudioside A, differing only in the presence of a xylose in place of a glucose. This difference is shown graphically in FIG. 2. Despite this structural similarity, rebaudioside F surprisingly lacks the sweetening qualities of rebaudioside A. For example, a 300 ppm rebaudioside A solution has a sweetness that is equivalent to an approximately 6% to 8% sugar solution. By contrast, rebaudioside F at 300 ppm is only about as sweet as a 3% sugar solution.

It has been surprisingly found, however, that although rebaudioside F is not a high potency sweetener like rebaudioside A or M, it can enhance the sweetness of certain other sweeteners. And when used as a sweetness enhancer, rebaudioside F enables reducing overall sweetener concentration in a given product.

Various examples and embodiments of the subject matter disclosed here are possible and will be apparent to a person of ordinary skill in the art, given the benefit of this disclosure. In this disclosure, reference to “some embodiments,” “certain embodiments,” “certain exemplary embodiments,” and similar phrases each means that those embodiments are non-limiting examples of the subject matter disclosed, and there are alternative embodiments which are not excluded.

### Definitions

The articles “a,” “an,” and “the” are used herein to refer to one or to more than one (i.e., to at least one) of the grammatical object of the article. By way of example, “an element” means one element or more than one element.

As used herein, the term “about” means±10% of the noted value. By way of example only, a composition comprising “about 30 weight percent” of a compound could include from 27 weight percent of the compound up to and including 33 weight percent of the compound.

The term “beverage syrup” refers to an aqueous sweetener composition suitable for use in beverage preparation. Exemplary embodiments are described in this disclosure.

As used herein, the term “Brix” means the sugar content of an aqueous solution (w/w). By way of example, a solution that is 1 degree Brix contains 1 g of sucrose in 100 g of solution, while a solution that is 5 degrees Brix contains 5 g sucrose in 100 g solution.

As used herein, a “full-calorie” beverage formulation is one that is fully sweetened with a nutritive sweetener.

As used herein, a “low-calorie” beverage formulation has fewer than 40 calories per 8 oz. serving of beverage.

As used herein, a “reduced-calorie” beverage formulation means a beverage having a reduced number of calories as compared to a full-calorie counterpart; more particularly, “reduced-calorie” typically means having at least a 25% reduction in calories per 8 oz. serving of beverage as compared to the full-calorie version, typically a previously commercialized full-calorie version.

As used herein, “zero-calorie” means having fewer than 5 calories per serving per 8 oz. for beverages.

As used herein, the term “non-nutritive sweetener” refers to all sweeteners other than nutritive sweeteners.

The term “nutritive sweetener” refers generally to sweeteners which provide significant caloric content in typical usage amounts, e.g., more than about 5 calories per 8 oz. serving of a beverage.

As used herein, a “sweetening amount” of a sweetener refers to the sweetener being present in an amount sufficient to contribute sweetness perceptible in a food product to a sensory panel. That is, as used here the term a “sweetening amount” means an amount or concentration that in the formulation of the food product in question causes sweetening that is perceptible to at least a majority of an expert sensory panel of the type commonly used in the food industry for making assessments of the taste properties of a beverage or other food.

As used herein, “taste” refers to a combination of sweetness perception, temporal effects of sweetness perception, i.e., on-set and duration, off-tastes, e.g., bitterness and metallic taste, residual perception (aftertaste), and tactile perception, e.g., body and thickness.

### Method of Enhancing Sweetness

In certain embodiments, the present disclosure provides a method of enhancing sweetness of a sweetener. In certain embodiments, the method can comprise combining the sweetener with an effective amount of rebaudioside F. In certain embodiments, the sweetener can be a nutritive sweetener, a non-nutritive sweetener, or a combination thereof.

In certain embodiments, the nutritive sweetener can be a natural nutritive sweetener. Exemplary natural nutritive sweeteners include, but are not limited to, crystalline or liquid sucrose; fructose, glucose, dextrose, maltose, trehalose, fructo-oligosaccharides, glucose-fructose syrup from natural sources such as apple, chicory, and honey; high fructose corn syrup, invert sugar, maple syrup, maple sugar, honey, brown sugar molasses, cane molasses, such as first molasses, second molasses, blackstrap and combinations of any of the foregoing.

In other embodiments, the sweetener can be a non-nutritive sweetener. Exemplary non-nutritive sweeteners include, but are not limited to, acesulfame-K, aspartame, advantame, cyclamate, neotame, alitame, saccharin, sucralose, steviol glycosides (including, but not limited to, stevioside, steviolbioside, rebaudioside A, rebaudioside B, rebaudioside C, rebaudioside D, rebaudioside E, rebaudioside H, rebaudioside I, rebaudioside N, rebaudioside K, rebaudioside J, rebaudioside O, rebaudioside M, dulcoside A, rubusoside, iso-steviol glycosides such as iso-rebaudioside A, and mixtures thereof), Lo Han Guo powder, neohesperidin dihydrochalcone, trilobatin, glycyrrhizin, phyllodulcin, hernandulcin, osladin, polypodoside A, baiyunoside, pterocaryoside, thaumatin, monellin, monatin, and mabinlins I and II, and combinations of any of the foregoing.

Although the non-nutritive sweetener can, in certain embodiments, be a steviol glycoside, in certain embodiments, the non-nutritive sweetener can be a non-nutritive sweetener other than a steviol glycoside. In particular embodiments, the non-nutritive sweetener can be a non-nutritive sweetener other than rebaudioside A, rebaudioside B, rebaudioside C, rebaudioside D, rebaudioside E, rebaudioside H, rebaudioside I, rebaudioside J, rebaudioside K, rebaudioside O, rebaudioside N, rebaudioside M, dulcoside A, rubusoside, iso-steviol glycosides such as iso-rebaudioside A, and mixtures of any of the foregoing. In particular embodiments, the non-nutritive sweetener can be any non-nutritive sweetener other than rebaudioside A.

In still further embodiments, the sweetener can be selected from the group consisting of high fructose corn syrup (HFCS), fructose, glucose, sucralose, aspartame, sucrose, and combinations thereof. In certain embodiments, the sweetener can be a combination of two or more of HFCS, fructose, glucose, sucralose, aspartame, and sucrose.

In certain embodiments, the effective amount of rebaudioside F suitable for combination with the sweetener can range from about 20 ppm to about 150 ppm. In certain embodiments, the effective amount of rebaudioside F can range from about 20 ppm to about 90 ppm. In certain embodiments, the effective amount of rebaudioside F suitable for combination with the sweetener can be about 20 ppm, about 25 ppm, about 30 ppm, about 35 ppm, about 40 ppm, about 45 ppm, about 50 ppm, about 55 ppm, about 60 ppm, about 65 ppm, about 70 ppm, about 75 ppm, about 80 ppm, about 85 ppm, about 90 ppm, about 95 ppm, about 100 ppm, about 105 ppm, about 110 ppm, about 115 ppm, about 120 ppm, about 125 ppm, about 130 ppm, about 135 ppm, about 140 ppm, about 145 ppm, or about 150 ppm. In certain embodiments, the effective amount of rebaudioside F can be about 30 ppm. In certain embodiments, the effective amount of rebaudioside F can be about 60 ppm. In certain embodiments, the effective amount of rebaudioside F can be about 90 ppm.

In certain embodiments, the method of enhancing sweetness of a sweetener can comprise combining the sweetener with an effective amount of rebaudioside F to result in an increase in sweetness ranging from about 1% to about 100%, relative to the sweetness of the sweetener in the absence of rebaudioside F. Percent sweetness enhancement can be measured using methodologies know to those of ordinary skill in the art, including, for example, the procedure described in Example 2.

In certain embodiments, the effective amount of rebaudioside F can increase sweetness of the sweetener by about 5% to about 95%, about 10% to about 95%, by about 15% to about 95%, by about 20% to about 95%, by about 25% to about 95%, by about 30% to about 95%, by about 35% to about 95%, by about 40% to about 95%, by about 45% to about 95%, by about 50% to about 95%, by about 55% to about 95%, by about 60% to about 95%, by about 65% to about 95%, by about 70% to about 95%, by about 75% to about 95%, by about 80% to about 95%, by about 85% to about 95%, or by about 90% to about 95%. In certain embodiments, the effective amount of rebaudioside F can increase sweetness by about 1%, by about 5%, by about 10%, by about 15%, by about 20%, by about 25%, by about 30%, by about 35%, by about 40%, by about 45%, by about 50%, by about 55%, by about 60%, by about 65%, by about 70%, by about 75%, by about 80%, by about 85%, by about 90%, by about 95%, or by about 100%.

In certain embodiments, the effective amount of rebaudioside F that results in an increase in sweetness from about 1% to about 100% relative to the sweetness of the sweetener in the absence of rebaudioside F can range from about 20 ppm to about 150 ppm rebaudioside F. In certain embodiments, the effective amount of rebaudioside F can range from about 20 ppm to about 90 ppm. In certain embodiments, the effective amount of rebaudioside F can be about 20 ppm, about 25 ppm, about 30 ppm, about 35 ppm, about 40 ppm, about 45 ppm, about 50 ppm, about 55 ppm, about 60 ppm, about 65 ppm, about 70 ppm, about 75 ppm, about 80 ppm, about 85 ppm, about 90 ppm, about 95 ppm, about 100 ppm, about 105 ppm, about 110 ppm, about 115 ppm, about 120 ppm, about 125 ppm, about 130 ppm, about 135 ppm, about 140 ppm, about 145 ppm, or about 150 ppm. In certain embodiments, the effective amount of rebaudioside F can be about 30 ppm. In certain embodiments, the effective amount of rebaudioside F can be about 60 ppm. In certain embodiments, the effective amount of rebaudioside F can be about 90 ppm.

In another embodiment, the present disclosure provides a method for reducing sweetener concentration in a given composition comprising replacing from about 0.01 weight percent to about 50 weight percent of the sweetener in the composition with from about 20 ppm to about 150 ppm rebaudioside F. In certain embodiments, the method for reducing sweetener concentration in a given formulation can comprise replacing about 0.01 weight percent, about 0.05 weight percent, about 0.1 weight percent, about 0.5 weight percent, about 1 weight percent, about 5 weight percent, about 10 weight percent, about 15 weight percent, about 20 weight percent, about 25 weight percent, about 30 weight percent, about 35 weight percent, about 40 weight percent, about 45 weight percent, or about 50 weight percent of the sweetener with from about 20 ppm to about 150 ppm rebaudioside F.

In some embodiments, the composition can be a beverage or a syrup. In certain embodiments, the sweetener can be a nutritive sweetener, a non-nutritive sweetener, or a combination thereof.

In certain embodiments, the nutritive sweetener can be a natural nutritive sweetener. Exemplary natural nutritive sweeteners include, but are not limited to, crystalline or liquid sucrose; fructose, glucose, dextrose, maltose, trehalose, fructo-oligosaccharides, glucose-fructose syrup from natural sources such as apple, chicory, and honey; high fructose corn syrup, invert sugar, maple syrup, maple sugar, honey, brown sugar molasses, cane molasses, such as first molasses, second molasses, blackstrap molasses and sugar beet molasses; and Lo Han Guo juice concentrate, sorghum syrup, and combinations of any of the foregoing.

In other embodiments, the sweetener can be a non-nutritive sweetener. Exemplary non-nutritive sweeteners include, but are not limited to, acesulfame-K, aspartame, advantame, cyclamate, alitame, neotame, saccharin, sucralose, steviol glycosides (e.g., stevioside, steviolbioside, rebaudioside A, rebaudioside B, rebaudioside C, rebaudioside D, rebaudioside E, rebaudioside H, rebaudioside I, rebaudioside J, rebaudioside K, rebaudioside M, rebaudioside N, rebaudioside O, dulcoside A, rubusoside, iso-steviol glycosides such as iso-rebaudioside A, and mixtures thereof), Lo Han Guo powder, neohesperidin dihydrochalcone, trilobatin, glycyrrhizin, phyllodulcin, hernandulcin, osladin, polypodoside A, baiyunoside, pterocaryoside, thaumatin, monellin, monatin, and mabinlins I and II, and combinations of any of the foregoing.

Although the non-nutritive sweetener can, in certain embodiments, be a steviol glycoside, in certain embodiments, the non-nutritive sweetener can be a non-nutritive sweetener other than a steviol glycoside. In particular embodiments, the non-nutritive sweetener can be a non-nutritive sweetener other than rebaudioside A, rebaudioside B, rebaudioside C, rebaudioside D, rebaudioside E, rebaudioside H, rebaudioside I, rebaudioside J, rebaudioside K, rebaudioside M, rebaudioside N, rebaudioside O, dulcoside A, rubusoside, iso-steviol glycosides such as iso-rebaudioside A, and mixtures thereof. In particular embodiments, the non-nutritive sweetener can be a sweetener other than rebaudioside A.

In still further embodiments, the sweetener can be selected from the group consisting of high fructose corn syrup (HFCS), fructose, glucose, sucralose, aspartame, sucrose, and combinations thereof. In certain embodiments, the sweetener can be sucrose. In certain embodiments, the sweetener can be a combination of two or more of HFCS, fructose, glucose, sucralose, aspartame, and sucrose.

### Beverages

In certain embodiments, the present disclosure provides a beverage comprising rebaudioside F. In certain embodiments, the beverage can comprise water, a sweetener, and an effective amount of rebaudioside F. In certain embodiments, the sweetener can be a nutritive sweetener, a non-nutritive sweetener, or a combination thereof.

In certain embodiments, the nutritive sweetener can be present in the beverage in a concentration ranging from about 2 degrees Brix to about 11 degrees Brix. In particular embodiments, the nutritive sweetener concentration in the beverage can be, or can be equivalent to, about 2 degrees Brix, about 2.5 degrees Brix, about 3 degrees Brix, about 3.5 degrees Brix, about 4 degrees Brix, about 4.5 degrees Brix, about 5 degrees Brix, about 5.5 degrees Brix, about 6 degrees Brix, about 6.5 degrees Brix, about 7 degrees Brix, about 7.5 degrees Brix, about 8 degrees Brix, about 8.5 degrees Brix, about 9 degrees Brix, about 9.5 degrees Brix, about 10 degrees Brix, about 10.5 degrees Brix, or about 11 degrees Brix.

In certain embodiments, the non-nutritive sweetener can be present in the beverage in a concentration ranging from about 50 ppm to about 600 ppm. In particular embodiments, the non-nutritive sweetener concentration can be about 50 ppm, about 100 ppm, about 150 ppm, about 175 ppm, about 200 ppm, about 225 ppm, about 250 ppm, about 275 ppm, about 300 ppm, about 325 ppm, about 350 ppm, about 375 ppm, about 400 ppm, about 425 ppm, about 450 ppm, about 475 ppm, about 500 ppm, about 525 ppm, about 550 ppm, about 575 ppm, or about 600 ppm.

In certain embodiments, the effective amount of rebaudioside F suitable for use in the beverage can range from about 20 ppm to about 150 ppm. In certain embodiments, the effective amount of rebaudioside F can range from about 20 ppm to about 90 ppm. In certain embodiments, the effective amount of rebaudioside F suitable for use in the beverage can be about 20 ppm, about 25 ppm, about 30 ppm, about 35 ppm, about 40 ppm, about 45 ppm, about 50 ppm, about 55 ppm, about 60 ppm, about 65 ppm, about 70 ppm, about 75 ppm, about 80 ppm, about 85 ppm, about 90 ppm, about 95 ppm, about 100 ppm, about 105 ppm, about 110 ppm, about 115 ppm, about 120 ppm, about 125 ppm, about 130 ppm, about 135 ppm, about 140 ppm, about 145 ppm, or about 150 ppm. In certain embodiments, the effective amount of rebaudioside F suitable for use in the beverage can be about 30 ppm. In certain embodiments, the effective amount of rebaudioside F suitable for use in the beverage can be about 60 ppm. In still further embodiments, the effective amount of rebaudioside F suitable for use in the beverage can be about 90 ppm.

In certain embodiments, the nutritive sweetener in the beverage can be a natural nutritive sweetener. Exemplary natural nutritive sweeteners include, but are not limited to, crystalline or liquid sucrose; fructose, glucose, dextrose, maltose, trehalose, fructo-oligosaccharides, glucose-fructose syrup from natural sources such as apple, chicory, and honey; high fructose corn syrup, invert sugar, maple syrup, maple sugar, honey, brown sugar molasses, cane molasses, such as first molasses, second molasses, blackstrap and combinations of any of the foregoing.

In other embodiments, the sweetener used in the beverage can be a non-nutritive sweetener. Exemplary non-nutritive sweeteners include, but are not limited to, acesulfame-K, aspartame, advantame, cyclamate, neotame, alitame, saccharin, sucralose, steviol glycosides (including, but not limited to, stevioside, steviolbioside, rebaudioside A, rebaudioside B, rebaudioside C, rebaudioside D, rebaudioside E, rebaudioside H, rebaudioside I, rebaudioside J, rebaudioside K, rebaudioside M, rebaudioside N, rebaudioside O, dulcoside A, rubusoside, iso-steviol glycosides such as iso-rebaudioside A, and mixtures thereof), Lo Han Guo powder, neohesperidin dihydrochalcone, trilobatin, glycyrrhizin, phyllodulcin, hernandulcin, osladin, polypodoside A, baiyunoside, pterocaryoside, thaumatin, monellin, monatin, and mabinlins I and II, and combinations of any of the foregoing.

Although the non-nutritive sweetener used in the beverage can be, in certain embodiments, a steviol glycoside, in certain embodiments, the non-nutritive sweetener used in the beverage can be a non-nutritive sweetener other than a steviol glycoside. In particular embodiments, the non-nutritive sweetener used in the beverage can be a non-nutritive sweetener other than rebaudioside A, rebaudioside B, rebaudioside C, rebaudioside D, rebaudioside E, rebaudioside H, rebaudioside I, rebaudioside J, rebaudioside K, rebaudioside M, rebaudioside N, rebaudioside O, dulcoside A, rubusoside, iso-steviol glycosides such as iso-rebaudioside A, and mixtures of any of the foregoing. In particular embodiments, the non-nutritive sweetener used in the beverage can be a non-nutritive sweetener other than rebaudioside A.

In certain embodiments, the sweetener used in the beverage can be selected from the group consisting of high fructose corn syrup (HFCS), fructose, glucose, sucralose, aspartame, sucrose, and combinations thereof. In certain embodiments, the sweetener used in the beverage can be a combination of two or more of HFCS, fructose, glucose, sucralose, aspartame, and sucrose.

In addition to including rebaudioside F as a sweetness enhancer, the beverages described herein can also include, in certain embodiments, a sugar alcohol. Exemplary sugar alcohols include, but are not limited to, erythritol, sorbitol, mannitol, xylitol, lactitol, isomalt, malitol, tagatose, trehalose, galactose, rhamnose, cyclodextrin, ribulose, threose, arabinose, xylose, lyxose, allose, altrose, mannose, idose, lactose, maltose, isotrehalose, neotrehalose, palatinose or isomaltulose, erythrose, deoxyribose, gulose, talose, erythrulose, xylulose, psicose, turanose, cellobiose, glucosamine, mannosamine, fucose, fuculose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, ketotriose (dehydroxyacetone), aldotriose (glyceraldehyde), nigero-oligosaccharides, fructooligosaccharides (kestose, nystose and the like), maltotetraose, maltotriol, tetrasaccharides, mannan-oligosaccharides, malto-oligosaccharides (maltotriose, maltotetraose, maltopentaose, maltohexaose, maltoheptaose and the like), dextrins, lactulose, melibiose, raffinose, rhamnose, and ribose, and combinations of any of the foregoing.

In certain embodiments, the beverage can also contain a rare sugar. Exemplary rare sugars include, but are not limited to, D-allose, D-psicose (also known as D-allulose), L-ribose, D-tagatose, L-glucose, L-fucose, L-arabinose, D-turanose, and D-leucrose, and combinations of any of the foregoing. In certain embodiments, the beverage can include at least a sweetening amount of any of the noted sugar alcohols and/or rare sugars, up to the FEMA GRAS concentration of the particular sugar alcohol or rare sugar that can be included in a beverage. Such limits are well known to those of ordinary skill in the art.

In certain embodiments, the beverage can be a coffee drink, a cola drink, a tea drink, a juice drink, a dairy drink, a sports drink, a ready-to-drink drink, a fountain drink, a frozen drink, a carbonated drink, a frozen carbonated drink, an energy drink, or a flavored water drink.

In certain embodiments, the beverage can be a reduced-calorie, low-calorie, or a zero-calorie beverage product. In certain embodiments, the beverages can further comprise at least one of caffeine, caramel and other colorants, artificial flavoring, natural flavoring, preservatives, antifoaming agents, gums, emulsifiers, tea solids, cloud components, minerals, antioxidants, and vitamins. In certain embodiments, the beverage can further comprise caffeine. In certain embodiments, the beverage can further comprise caramel and other colorants. In certain embodiments, the beverage can comprise two or more of caffeine, caramel and other colorants, artificial flavoring, natural flavoring, preservatives, antifoaming agents, gums, emulsifiers, tea solids, cloud components, minerals, antioxidants, and vitamins.

In certain embodiments, the beverage can be a cola-flavored carbonated beverage, characteristically containing, in addition to the ingredients included in the beverages disclosed herein, carbonated water, sweetener, kola nut extract and/or other flavorings, caramel coloring, phosphoric acid, and optionally other ingredients. Additional and alternative suitable ingredients will be recognized by those skilled in the art given the benefit of this disclosure.

In certain embodiments, the beverage disclosed herein can contain a flavor composition, for example, natural, nature identical, and/or synthetic fruit flavors, botanical flavors, other flavors, and mixtures thereof. The particular amount of the flavor component useful for imparting flavor characteristics to the beverages of the present disclosure will depend upon the flavor(s) selected, the flavor impression desired, and the form of the flavor component. Those skilled in the art, given the benefit of this disclosure, will be readily able to determine the amount of any particular flavor component(s) used to achieve the desired flavor impression.

As used here, the term “botanical flavor” refers to flavors derived from parts of a plant other than the fruit. As such, botanical flavors can include those flavors derived from essential oils and extracts of nuts, bark, roots, and leaves. Also included within the term “botanical flavor” are synthetically prepared flavors made to simulate botanical flavors derived from natural sources. Examples of such flavors include cola flavors, tea flavors, and mixtures thereof. In certain embodiments of the beverage, a cola flavor component or a tea flavor component can be used.

As used herein, the term “fruit flavor” refers to those flavors derived from the edible reproductive part of a seed plant including those plants wherein a sweet pulp is associated with the seed, e.g., tomato, cranberry, and the like, and those having a small, fleshy berry. The term berry includes true berries as well as aggregate fruits, i.e., not “true” berries, but fruit commonly accepted as such. Also included within the term “fruit flavor” are synthetically prepared flavors made to simulate fruit flavors derived from natural sources. Examples of suitable fruit or berry sources include whole berries or portions thereof, berry juice, berry juice concentrates, berry purees and blends thereof, dried berry powders, dried berry juice powders, and the like.

Exemplary fruit flavors can include citrus flavors, e.g., orange, lemon, lime, grapefruit, tangerine, mandarin orange, tangelo, and pomelo, apple, grape, cherry, and pineapple flavors. In certain embodiments, the beverage can comprise a fruit flavor component, e.g., a juice concentrate or juice.

Juices suitable for use in the beverages disclosed herein include, but are not limited to, fruit, vegetable, and berry juices. Juices can be employed in the beverages in the form of a concentrate, puree, single-strength juice, or other suitable forms. The term “juice” as used here includes single-strength fruit, berry, or vegetable juice, as well as concentrates, purees, milks, and other forms. Multiple different fruit, vegetable, and/or berry juices can be combined, optionally along with other flavorings, to generate a concentrate or beverage having a desired flavor. Examples of suitable juice sources include plum, prune, date, currant, fig, grape, raisin, cranberry, pineapple, peach, banana, apple, pear, guava, apricot, Saskatoon berry, blueberry, plains berry, prairie berry, mulberry, elderberry, Barbados cherry (acerola cherry), choke cherry, date, coconut, olive, raspberry, strawberry, huckleberry, loganberry, currant, dewberry, boysenberry, kiwi, cherry, blackberry, quince, buckthorn, passion fruit, sloe, rowan, gooseberry, pomegranate, persimmon, mango, rhubarb, papaya, litchi, lemon, orange, lime, tangerine, mandarin, melon, watermelon, and grapefruit. Numerous additional and alternative juices suitable for use in at least certain exemplary embodiments will be apparent to those skilled in the art given the benefit of this disclosure. In the compositions of the present disclosure employing juice, juice can be used, for example, at a level of at least about 0.2 weight percent of the composition. In certain embodiments juice can be employed at a level of from about 0.2 weight percent to about 40 weight percent. In further embodiments, juice can be used, if at all, in an amounts ranging from about 1 weight percent to about 20 weight percent.

Juices that are lighter in color can be included in the beverages described herein to adjust the flavor and/or increase the juice content of the beverage without darkening the beverage color. Examples of such juices include, but are not limited to, apple, pear, pineapple, peach, lemon, lime, orange, apricot, grapefruit, tangerine, rhubarb, cassis, quince, passion fruit, papaya, mango, guava, litchi, kiwi, mandarin, coconut, and banana. Deflavored and decolored juices can be employed if desired.

Other flavorings suitable for use the beverages described herein include, but are not limited to, cassia, clove, cinnamon, pepper, ginger, vanilla spice flavorings, cardamom, coriander, root beer, sassafras, ginseng, and others. Numerous additional and alternative flavorings suitable for use in the beverages described herein will be apparent to those skilled in the art given the benefit of this disclosure. Flavorings can be in the form of an extract, oleoresin, juice concentrate, bottler's base, or other forms known in the art. In certain embodiments, the spice or other flavors complement that of a juice or juice combination.

The one or more flavorings can be used in the form of an emulsion. A flavoring emulsion can be prepared by mixing some or all of the flavorings together, optionally together with other ingredients of the beverage, and an emulsifying agent. The emulsifying agent can be added with or after the flavorings mixed together. In certain embodiments the emulsifying agent can be water-soluble. Exemplary suitable emulsifying agents include gum acacia, modified starch, carboxymethylcellulose, gum tragacanth, gum ghatti, and other suitable gums. Additional suitable emulsifying agents will be apparent to those skilled in the art of food or beverage formulations, given the benefit of this disclosure. In certain embodiments, the emulsifier can comprise greater than about 3% of the mixture of flavorings and emulsifier. In certain embodiments the emulsifier can be from about 5% to about 30% of the mixture.

In certain embodiments, carbon dioxide can be used to provide effervescence to the beverages disclosed here. Any techniques and carbonating equipment known in the art for carbonating beverages can be employed. Carbon dioxide can enhance beverage taste and appearance and can aid in safeguarding the beverage purity by inhibiting and/or destroying objectionable bacteria. In certain embodiments, for example, the beverage can have a CO₂ level up to about 4.0 volumes carbon dioxide. Other embodiments can have, for example, from about 0.5 volume to about 5.0 volumes of carbon dioxide. As used herein, one volume of carbon dioxide refers to the amount of carbon dioxide absorbed by a given quantity of a given liquid, such as water, at 60° F. (16° C.) and one atmosphere of pressure. A volume of gas occupies the same space as does the liquid by which it is dissolved. The carbon dioxide content can be selected by those skilled in the art based on the desired level of effervescence and the impact of the carbon dioxide on the taste or mouthfeel of the beverage.

In certain embodiments, caffeine can be added to any of the beverages described herein. For example, the amount of caffeine added can be determined by the desired properties of a given beverage, and any applicable regulatory provisions of the country where the beverage or syrup is marketed. In certain embodiments caffeine can be included in an amount sufficient to provide a final beverage having less than about 0.02 weight percent caffeine. The caffeine must be of purity acceptable for use in beverages. The caffeine can be natural or synthetic in origin.

The beverages disclosed here can contain additional ingredients, including, generally, any of those typically found in beverage formulations. Examples of such additional ingredients include, but are not limited to, caramel and other coloring agents or dyes, foaming or antifoaming agents, gums, emulsifiers, tea solids, cloud components, and mineral and non-mineral nutritional supplements. Examples of non-mineral nutritional supplement ingredients are known to those of ordinary skill in the art and include, for example, antioxidants and vitamins, including Vitamins A, D, E (tocopherol), C (ascorbic acid), B (thiamine), B2 (riboflavin), B6, B12, K, niacin, folic acid, biotin, and combinations thereof. The optional non-mineral nutritional supplements are typically present in amounts generally accepted under good manufacturing practices. Exemplary amounts can be between about 1% and about 100% Recommended Daily Value (RDV), where such RDVs are established. In certain exemplary embodiments the non-mineral nutritional supplement ingredient(s) can be present in an amount of from about 5% to about 20% RDV, where established.

Preservatives can be used in at least certain embodiments of the beverages disclosed here. That is, at least certain exemplary embodiments can contain an optional dissolved preservative system. Solutions with a pH below 4 and especially those below 3 typically are “micro-stable,” i.e., they resist growth of microorganisms, and so are suitable for longer term storage prior to consumption without the need for further preservatives. However, an additional preservative system can be used if desired. If a preservative system is used, it can be added to the product at any suitable time during production, e.g., in some cases prior to the addition of sweeteners. As used here, the terms “preservation system” or “preservatives” include all suitable preservatives approved for use in food or beverage compositions, including, without limitation, such known chemical preservatives as benzoates, e.g., sodium, calcium, and potassium benzoate, sorbates, e.g., sodium, calcium, and potassium sorbate, citrates, e.g., sodium citrate and potassium citrate, polyphosphates, e.g., sodium hexametaphosphate (SHMP), and mixtures thereof, and antioxidants such as ascorbic acid, EDTA, BHA, BHT, TBHQ, dehydroacetic acid, dimethyldicarbonate, ethoxyquin, heptylparaben, and combinations thereof. Preservatives can be used in amounts not exceeding mandated maximum levels under applicable laws and regulations.

In the case of beverages in particular, the level of preservative used can be adjusted according to the planned final product pH and/or the microbiological spoilage potential of the particular beverage formulation. The maximum level employed typically is about 0.05 weight percent of the beverage. It will be within the ability of those skilled in the art, given the benefit of this disclosure, to select a suitable preservative or combination of preservatives for beverage products according to this disclosure.

Other methods of preservation suitable for preserving the beverages disclosed herein include, but are not limited to, aseptic packaging and/or heat treatment or thermal processing steps, such as hot filling and tunnel pasteurization. Such steps can be used to reduce yeast, mold, and microbial growth in the beverages. For example, U.S. Pat. No. 4,830,862 discloses the use of pasteurization in the production of fruit juice beverages as well as the use of suitable preservatives in carbonated beverages. U.S. Pat. No. 4,925,686 discloses a heat-pasteurized freezable fruit juice composition which contains sodium benzoate and potassium sorbate. Both of these patents are incorporated by reference in their entireties. In general, heat treatment includes hot fill methods typically using high temperatures for a short time, e.g., about 190° F. for 10 seconds, tunnel pasteurization methods typically using lower temperatures for a longer time, e.g., about 160° F. for 10-15 minutes, and retort methods typically using, e.g., about 250° F. for 3-5 minutes at elevated pressure, i.e., at pressure above 1 atmosphere.

Suitable antioxidants can be selected from the group consisting of rutin, quercetin, flavonones, flavones, dihydroflavonols, flavonols, flavandiols, leucoanthocyanidins, flavonol glycosides, flavonone glycosides, isoflavonoids, and neoflavonoids. The flavonoids can be, but are not limited to, quercetin, eriocitrin, neoeriocitrin, narirutin, naringin, hesperidin, hesperetin, neohesperidin, neoponcirin, poncirin, rutin, isorhoifolin, rhoifolin, diosmin, neodiosmin, sinensetin, nobiletin, tangeritin, catechin, catechin gallate, epigallocatechin, epigallocatechin gallate, oolong tea polymerized polyphenol, anthocyanin, heptamethoxyflavone, daidzin, daidzein, biochaminn A, prunetin, genistin, glycitein, glycitin, genistein, 6,7,4′-trihydroxy isoflavone, morin, apigenin, vitexin, balcalein, apiin, cupressuflavone, datiscetin, diosmetin, fisetin, galangin, gossypetin, geraldol, hinokiflavone, primuletin, pratol, luteolin, myricetin, orientin, robinetin, quercetagetin, and hydroxy-4-flavone.

Suitable food grade acids can be water soluble organic acids and their salts and include, for example, phosphoric acid, sorbic acid, ascorbic acid, benzoic acid, citric acid, tartaric acid, propionic acid, butyric acid, acetic acid, succinic acid, glutaric acid, maleic acid, malic acid, valeric acid, caproic acid, malonic acid, aconitic acid, potassium sorbate, sodium benzoate, sodium citrate, amino acids, and combinations of any of them. Such acids are suitable for adjusting the pH of the food or beverage. In certain embodiments, the pH can range from about 2.5 to about 8. In certain embodiments, the pH can range from about 2.5 to about 7, or from about 2.5 to about 5, or from about 2.5 to about 4. In certain embodiments, the pH can be about 2.5, about 3, about 3.5, about 4, about 4.5, about 5, about 5.5, about 6, about 6.5, about 7, about 7.5, or about 8.

Suitable food grade bases include, but are not limited to, sodium hydroxide, potassium hydroxide, and calcium hydroxide. Such bases also are suitable for adjusting the pH of a food or beverage.

It should be understood that the beverages in accordance with this disclosure can have any of numerous different specific formulations or constitutions. The formulation of a beverage product in accordance with this disclosure can vary, depending upon such factors as the product's intended market segment, its desired nutritional characteristics, flavor profile, and the like. For example, further ingredients can be added to the formulation of a particular food or beverage embodiment. Further ingredients include, but are not limited to flavorings, electrolytes, vitamins, fruit juices or other fruit products, tastants, masking agents, flavor enhancers, carbonation, or any combination of the foregoing. These can be added to any of the beverages to vary the taste, mouthfeel, and/or nutritional characteristics of the beverage.

### Beverage Syrups

In certain embodiments, the present disclosure provides a beverage syrup comprising rebaudioside F. Typically, the beverage syrup comprises water, a sweetener, and an effective amount of rebaudioside F. In certain embodiments, the sweetener can be a nutritive sweetener, a non-nutritive sweetener, or a combination thereof.

In certain embodiments, the effective amount of rebaudioside F suitable for use in a beverage syrup can range from about 100 ppm to about 900 ppm, and in certain embodiments, from about 120 ppm to about 720 ppm. In certain embodiments, the effective amount of rebaudioside F in the beverage syrup can range from about 120 ppm to about 540 ppm. In certain embodiments, the effective amount of rebaudioside F suitable for use in the beverage syrup can be about 120 ppm, about 150 ppm, about 180 ppm, about 210 ppm, about 240 ppm, about 270 ppm, about 300 ppm, about 330 ppm, about 360 ppm, about 390 ppm, about 420 ppm, about 450 ppm, about 480 ppm, about 510 ppm, about 540 ppm, about 570 ppm, about 600 ppm, about 630 ppm, about 660 ppm, about 690 ppm, about 720 ppm, about 750 ppm, about 780 ppm, about 810 ppm, about 840 ppm, about 870 ppm, or about 900 ppm. In certain embodiments, the effective amount of rebaudioside F can be about 180 ppm. In certain embodiments, the effective amount of rebaudioside F can be about 360 ppm. In certain embodiments, the effective amount of rebaudioside F can be about 540 ppm.

In certain embodiments, the nutritive sweetener in the beverage syrup can be a natural nutritive sweetener. Exemplary natural nutritive sweeteners include, but are not limited to, crystalline or liquid sucrose; fructose, glucose, dextrose, maltose, trehalose, fructo-oligosaccharides, glucose-fructose syrup from natural sources such as apple, chicory, and honey; high fructose corn syrup, invert sugar, maple syrup, maple sugar, honey, brown sugar molasses, cane molasses, such as first molasses, second molasses, blackstrap molasses and sugar beet molasses; and Lo Han Guo juice concentrate, sorghum syrup, and combinations of any of the foregoing.

In other embodiments, the sweetener in the beverage syrup can be a non-nutritive sweetener. Exemplary non-nutritive sweeteners suitable for use in the beverage syrup include, but are not limited to, acesulfame-K, aspartame, advantame, cyclamate, neotame, alitame, saccharin, sucralose, steviol glycosides (including, but not limited to, stevioside, steviolbioside, rebaudioside A, rebaudioside B, rebaudioside C, rebaudioside D, rebaudioside E, rebaudioside H, rebaudioside I, rebaudioside N, rebaudioside K, rebaudioside J, rebaudioside O, rebaudioside M, dulcoside A, rubusoside, iso-steviol glycosides such as iso-rebaudioside A, and mixtures thereof), Lo Han Guo powder, neohesperidin dihydrochalcone, trilobatin, glycyrrhizin, phyllodulcin, hernandulcin, osladin, polypodoside A, baiyunoside, pterocaryoside, thaumatin, monellin, monatin, and mabinlins I and II, and combinations of any of the foregoing.

Although the non-nutritive sweetener used in the syrup can be, in certain embodiments, a steviol glycoside, in certain embodiments, the non-nutritive sweetener used in the syrup can be a non-nutritive sweetener other than a steviol glycoside. In particular embodiments, the non-nutritive sweetener used in the syrup can be a non-nutritive sweetener other than rebaudioside A, rebaudioside B, rebaudioside C, rebaudioside D, rebaudioside E, rebaudioside H, rebaudioside I, rebaudioside J, rebaudioside K, rebaudioside M, rebaudioside N, rebaudioside O, dulcoside A, rubusoside, iso-steviol glycosides such as iso-rebaudioside A, and mixtures of any of the foregoing. In particular embodiments, the non-nutritive sweetener used in the syrup can be a non-nutritive sweetener other than rebaudioside A.

In still further embodiments, the sweetener used in the syrup can be selected from the group consisting of high fructose corn syrup (HFCS), fructose, glucose, sucralose, aspartame, sucrose, and combinations thereof. In certain embodiments, the sweetener used in the syrup can be a combination of two or more of HFCS, fructose, glucose, sucralose, aspartame, and sucrose.

The amount of sweetener in the used in syrup can vary based on the desired sweetness of the beverage resulting from eventual dilution of the syrup. That said, and in certain embodiments, the syrup can contain an amount of sweetener suitable to provide an about 2 to about 11 brix solution of the sweetener, when one part syrup is diluted with five parts water. In certain embodiments, the syrup can contain an amount of sweetener suitable to provide a solution having about 2 degrees Brix, about 2.5 degrees Brix, about 3 degrees Brix, about 3.5 degrees Brix, about 4 degrees Brix, about 4.5 degrees Brix, about 5 degrees Brix, about 5.5 degrees Brix, about 6 degrees Brix, about 6.5 degrees Brix, about 7 degrees Brix, about 7.5 degrees Brix, about 8 degrees Brix, about 8.5 degrees Brix, about 9 degrees Brix, about 9.5 degrees Brix, about 10 degrees Brix, about 10.5 degrees Brix, or about 11 degrees Brix, after diluting 1 part syrup with 5 parts water.

In other embodiments, the syrup can contain an amount of sweetener suitable to provide a sweetener concentration ranging from about 50 ppm to about 600 ppm, when one part syrup is diluted with five parts water. More specifically, the syrup can comprise from about 300 ppm to about 3600 ppm of the sweetener, such as for example, any of the non-nutritive sweeteners noted herein.

It is within the skill of the ordinarily skilled artisan to select the appropriate amount of sweetener to include in the syrup based on the concentration of sweetener that is desired in a given finished beverage product.

In addition to including rebaudioside F, the beverage syrups described herein can also include, in certain embodiments, a sugar alcohol. Exemplary sugar alcohols include, but are not limited to, erythritol, sorbitol, mannitol, xylitol, lactitol, isomalt, malitol, tagatose, trehalose, galactose, rhamnose, cyclodextrin, ribulose, threose, arabinose, xylose, lyxose, allose, altrose, mannose, idose, lactose, maltose, isotrehalose, neotrehalose, palatinose or isomaltulose, erythrose, deoxyribose, gulose, talose, erythrulose, xylulose, psicose, turanose, cellobiose, glucosamine, mannosamine, fucose, fuculose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, ketotriose (dehydroxyacetone), aldotriose (glyceraldehyde), nigero-oligosaccharides, fructooligosaccharides (kestose, nystose and the like), maltotetraose, maltotriol, tetrasaccharides, mannan-oligosaccharides, malto-oligosaccharides (maltotriose, maltotetraose, maltopentaose, maltohexaose, maltoheptaose and the like), dextrins, lactulose, melibiose, raffinose, rhamnose, and ribose, and combinations of any of the foregoing.

In certain embodiments, the beverage syrup can also contain a rare sugar. Exemplary rare sugars include, but are not limited to, D-allose, D-psicose (also known as D-allulose), L-ribose, D-tagatose, L-glucose, L-fucose, L-arabinose, D-turanose, and D-leucrose, and combinations of any of the foregoing.

The beverage syrup can also contain one or more acids. Suitable acids for use in the beverage syrup include, but are not limited to, phosphoric acid, sorbic acid, ascorbic acid, benzoic acid, citric acid, tartaric acid, propionic acid, butyric acid, acetic acid, succinic acid, glutaric acid, maleic acid, malic acid, valeric acid, caproic acid, malonic acid, aconitic acid, potassium sorbate, sodium benzoate, sodium citrate, amino acids, and combinations thereof.

The beverage syrup can also contain any of the flavorings, preservatives, or other additives included suitable for including in the beverage disclosed herein.

Any and all of these additional components can be present in the syrup in a concentration sufficient to provide a beverage comprising the component in a perceptible concentration, but in an amount less than or equal to the FEMA GRAS concentration for that component, when one part syrup is diluted with five parts water.

### Sweetener Compositions

The present disclosure further provides a sweetener composition. The sweetener composition can comprise a sweetener and an effective amount of rebaudioside F. In certain embodiments, the sweetener can be a nutritive sweetener, a non-nutritive sweetener, or a combination thereof. In certain embodiments, the sweetener composition can be a solid, and in other embodiments, the sweetener composition can be a liquid.

In embodiments wherein the sweetener is a nutritive sweetener, the effective amount of rebaudioside F suitable for use in the sweetener composition can range from about 20 ppm to about 150 ppm, with the remainder of the composition comprising the sweetener. In certain embodiments, the effective amount of rebaudioside F in the sweetener composition can range from about 20 ppm to about 90 ppm. In certain embodiments, the effective amount of rebaudioside F suitable for use in the sweetener composition can be about 20 ppm, about 25 ppm, about 30 ppm, about 35 ppm, about 40 ppm, about 45 ppm, about 50 ppm, about 55 ppm, about 60 ppm, about 65 ppm, about 70 ppm, about 75 ppm, about 80 ppm, about 85 ppm, about 90 ppm, about 95 ppm, about 100 ppm, about 105 ppm, about 110 ppm, about 115 ppm, about 120 ppm, about 125 ppm, about 130 ppm, about 135 ppm, about 140 ppm, about 145 ppm, or about 150 ppm. In certain embodiments, the effective amount of rebaudioside F in the sweetener composition can be about 30 ppm. In certain embodiments, the effective amount of rebaudioside F in the sweetener composition can be about 60 ppm. In certain embodiments, the effective amount of rebaudioside F in the sweetener composition can be about 90 ppm.

In embodiments where the sweetener is a non-nutritive sweetener, and in particular when the non-nutritive sweetener is a high intensity sweetener, rebaudioside F can comprise from about 1 weight percent to about 50 weight percent of the composition, from about 1 to about 25 weight percent of the composition, from about 1 to about 20 weight percent of the composition, from about 1 to about 15 weight percent of the composition, or from about 1 to about 10 weight percent of the composition. In other embodiments, rebaudioside F can comprise about 1 weight percent, about 5 weight percent, about 10 weight percent, about 15 weight percent, about 20 weight percent, about 25 weight percent, about 30 weight percent, about 35 weight percent, about 40 weight percent, about 45 weight percent, or about 50 weight percent of the sweetener composition.

In certain embodiments, the nutritive sweetener in the sweetener composition can be a natural nutritive sweetener. Exemplary natural nutritive sweeteners include, but are not limited to, crystalline or liquid sucrose; fructose, glucose, dextrose, maltose, trehalose, fructo-oligosaccharides, glucose-fructose syrup from natural sources such as apple, chicory, and honey; high fructose corn syrup, invert sugar, maple syrup, maple sugar, honey, brown sugar molasses, cane molasses, such as first molasses, second molasses, blackstrap molasses and sugar beet molasses; and Lo Han Guo juice concentrate, sorghum syrup, and combinations of any of the foregoing.

In other embodiments, the sweetener in the sweetener composition can be a non-nutritive sweetener. Exemplary non-nutritive sweeteners include, but are not limited to, acesulfame-K, aspartame, advantame, cyclamate, neotame, alitame, saccharin, sucralose, steviol glycosides (including, but not limited to, stevioside, steviolbioside, rebaudioside A, rebaudioside B, rebaudioside C, rebaudioside D, rebaudioside E, rebaudioside H, rebaudioside I, rebaudioside J, rebaudioside K, rebaudioside M, rebaudioside N, rebaudioside O, dulcoside A, rubusoside, iso-steviol glycosides such as iso-rebaudioside A, and mixtures thereof), Lo Han Guo powder, neohesperidin dihydrochalcone, trilobatin, glycyrrhizin, phyllodulcin, hernandulcin, osladin, polypodoside A, baiyunoside, pterocaryoside, thaumatin, monellin, monatin, and mabinlins I and II, and combinations of any of the foregoing.

Although the non-nutritive sweetener can be, in certain embodiments, a steviol glycoside, in certain embodiments, the non-nutritive sweetener can be a non-nutritive sweetener other than a steviol glycoside. In particular embodiments, the non-nutritive sweetener in the sweetener composition can be a non-nutritive sweetener other than rebaudioside A, rebaudioside B, rebaudioside C, rebaudioside D, rebaudioside E, rebaudioside H, rebaudioside I, rebaudioside J, rebaudioside K, rebaudioside M, rebaudioside N, rebaudioside O, dulcoside A, rubusoside, iso-steviol glycosides such as iso-rebaudioside A, and mixtures of any of the foregoing. In particular embodiments, the non-nutritive sweetener in the sweetener composition can be a non-nutritive sweetener other than rebaudioside A.

In still further embodiments, the sweetener in the sweetener composition can be selected from the group consisting of high fructose corn syrup (HFCS), fructose, glucose, sucralose, aspartame, sucrose, and combinations thereof. In other embodiments, the sweetener in the sweetener composition can be a combination of two or more of HFCS, fructose, glucose, sucralose, aspartame, and sucrose.

The sweetener composition described herein can also include, in certain embodiments, a sugar alcohol. Exemplary sugar alcohols include, but are not limited to, erythritol, sorbitol, mannitol, xylitol, lactitol, isomalt, malitol, tagatose, trehalose, galactose, rhamnose, cyclodextrin, ribulose, threose, arabinose, xylose, lyxose, allose, altrose, mannose, idose, lactose, maltose, isotrehalose, neotrehalose, palatinose or isomaltulose, erythrose, deoxyribose, gulose, talose, erythrulose, xylulose, psicose, turanose, cellobiose, glucosamine, mannosamine, fucose, fuculose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, ketotriose (dehydroxyacetone), aldotriose (glyceraldehyde), nigero-oligosaccharides, fructooligosaccharides (kestose, nystose and the like), maltotetraose, maltotriol, tetrasaccharides, mannan-oligosaccharides, malto-oligosaccharides (maltotriose, maltotetraose, maltopentaose, maltohexaose, maltoheptaose and the like), dextrins, lactulose, melibiose, raffinose, rhamnose, and ribose, and combinations of any of the foregoing. In particular embodiments, the sweetener composition can include erythritol.

In certain embodiments, the sweetener composition can also contain a rare sugar. Exemplary rare sugars include, but are not limited to, D-allose, D-psicose (also known as D-allulose), L-ribose, D-tagatose, L-glucose, L-fucose, L-arabinose, D-turanose, and D-leucrose, and combinations of any of the foregoing. In particular embodiments, the rare sugar can be D-psicose or D-tagatose.

### EXAMPLES

The methods, compositions, and beverages described herein are now further detailed with reference to the following examples. These examples are provided for the purpose of illustration only and the embodiments described herein should in no way be construed as being limited to these examples. Rather, the embodiments should be construed to encompass any and all variations which become evident as a result of the teaching provided herein.

### Example 1: Evaluation of Sweetening Enhancement in Forced-Choice Test

A 300 ppm rebaudioside A solution was prepared by dissolving 30 mg of rebaudioside A in 100 mL of pH 3.1 water (phosphoric acid) at room temperature.

A 4° Brix HFCS solution was prepared by dissolving 50.89 g of 78.60° Brix HFCS in 1000 g phosphoric acid base prepared by adding phosphoric acid drop-wise into 1 L of AQUAFINA water until the pH was 3.1.

Fructose, glucose, sucralose, and aspartame solutions including the amount of sweetener specified in Table 1 were prepared by weighing the appropriate amount of sweetener and dissolved it at room temperature in pH 3.1 water (phosphoric acid).

TABLE 1

| Sweetener | Weight Sweetener (g) | Total Weight Solution (g) |
|---|---|---|
| Glucose | 42.29 | 507.7 |
| Fructose | 17.42 | 523.1 |
| Sucralose | 0.280 | 1000.2 |
| Aspartame | 0.220 | 1000.1 |

Tasting protocol: 13-18 tasters were provided with a first liquid sample containing a given volume of an aqueous solution of rebaudioside A, HFCS, fructose, glucose, sucralose, or aspartame, all prepared as described above, and in the concentrations noted in Table 2. Tasters were also provided with an otherwise identical sample also containing rebaudioside F at the concentration shown in Table 2. Tasters were asked to determine which sample tasted sweeter. Tasters did not eat at least 1 hour before tasting and rinsed with AQUAFINA water at least 5 times between tasting each sample. Tasters wore nose clips and were blinded to the identity of the test material. The results of this study are shown in Table 2.

TABLE 2

| | Rebaudioside F | |
|---|---|---|
| Sweetener Solution | Concentration | Results |
| Reb A (300 ppm) | 30 ppm | 11 out of 18 reported |
| | | enhancement |
| Reb A (300 ppm) | 60 ppm | 5 out of 13 reported |
| | | enhancement |
| Reb A (300 ppm) | 90 ppm | 6 out of 14 reported |
| | | enhancement |
| 4° Brix HFCS | 30 ppm | 9 out of 14 reported |
| | | enhancement |
| 4° Brix HFCS | 60 ppm | 11 out of 13 reported |
| | | enhancement |
| 4° Brix HFCS | 90 ppm | 14 out of 14 reported |
| | | enhancement |
| Fructose solution equi-sweet | 60 ppm | 11 out of 14 reported |
| to 5° Brix sucrose | | enhancement |
| Glucose solution equi-sweet | 60 ppm | 12 out of 14 reported |
| to 5° Brix sucrose | | enhancement |
| Sucralose solution equi-sweet | 60 ppm | 16 out of 16 reported |
| to 5° Brix sucrose | | enhancement |
| Aspartame solution equi-sweet | 60 ppm | 14 out of 16 reported |
| to 5° Brix sucrose | | enhancement |

As shown in Table 2, a majority of tasters reported that rebaudioside F enhanced the sweetness of HFCS, fructose, glucose, sucralose, and aspartame. All testers reported that adding 90 ppm rebaudioside F to a 4° Brix HFCS solution resulted in the solution having enhanced sweetness relative to the solution without rebaudioside F. All testers likewise reported that adding 60 ppm rebaudioside F to a sucralose solution equi-sweet to a 5° Brix sucrose solution resulted in the solution having enhanced sweetness relative to the same solution without rebaudioside F.

Surprisingly, rebaudioside F only minimally enhanced the sweetness of a 300 ppm rebaudioside A solution. Without wishing to be bound by a particular theory, it is believed that rebaudioside F's effectiveness was reduced in this solution because rebaudioside F and rebaudioside A bind to the same sweet taste receptors and rebaudioside A bound to the receptor preferentially.

### Example 2: Evaluation of Magnitude of Sweetening Enhancement

Percent sweetness enhancement is evaluated as follows: Four samples were prepared: (1) a 25% reduced sweetener control sample (without rebaudioside F) is prepared; (2) a 50% reduced sweetener control sample without rebaudioside F is prepared; (3) a test sample with (either solution 1 or solution 2) with a known quantity of rebaudioside F is prepared; and (4) a benchmark sample containing a “high concentration” of the sweetener used in the control samples (two times the concentration of the 50% reduced sweetener control sample) is prepared. Samples are evaluated in a system containing phosphoric acid, pH=3.1, or citric acid of similar pH.

Tasters, wearing nose clips, are then provided with a portion of each of the four samples and asked to rank the four samples in order of sweet intensity, from low sweet to high sweet. Samples are evaluated in triplicate. The amount of enhancement is estimated based on the rank order of the samples and are analyzed with Friedman's Test, followed by Tukey's.

### Example 3: Isolation of Rebaudioside F—Method 1

Stevia rebaudiana extract (procured from TianJin Tianping Biotech Co. Ltd.) containing 0.18% rebaudioside F as determined by UV detection at 210 nm was dissolved in methanol at approximately 200 mg/mL and allowed to crystallize. The crystalized material was separated via filtration and discarded but the mother liquor was retained. 350 g of the mother liquor, containing about 1.44% rebaudioside F, was then adhered onto 450 g of silica gel and loaded on top of a normal phase column (200×200 mm length) packed with an additional 1 kg of 100-200 mesh silica gel. Fractions were eluted using CH₂Cl₂:MeOH:H₂O (100:0:0, 100:9.5:0.5, 100:19:1, 100:47:3, 0:80:20) and 3 L were collected in fractions. Fractions containing rebaudioside F (LCMS) were combined and all volatiles were removed under reduced pressure to give about 120 g of a material enriched in rebaudioside F.

The material enriched in rebaudioside F was dissolved in H₂O, and a 120 g sample was subject to prep-HPLC on an MPLC-C18 column (MPLC Buchi C620, chromatography column ODS (Yamazen ODS-C18 500×80 mm, 40-60 μm)). The mobile phase was acetonitrile:water containing 0.1% TFA. Fractions containing rebaudioside F were pooled and solvent was evaporated to yield 45 g of crude material containing about 2.36% rebaudioside F.

The crude material (45 g) was then dissolved in H₂O and chromatographed again using the MPLC-C18 column (MPLC Buchi C620, chromatography column ODS (Yamazen ODS-C18 500×80 mm, 40-60 μm)). The mobile phase was acetonitrile(A):water(B) containing 0.1% TFA and the sample was eluted using the following gradient: 20% B for 2 min, 20-100% B over 45 min, and 100% B for 15 min. The flow rate was 100 mL/min. Fractions containing rebaudioside F were pooled and solvent was evaporated to yield 15 g of a further refined sample containing ˜3.5%-4.5% rebaudioside F.

The further refined sample was dissolved in H₂O, and 1 g aliquots were injected, and separated, by prep-HPLC (prep-HPLC, SHIMADZU, chromatography column ODS (Daiso C18 300×50.0 mm, 10 μm)). The mobile phase was acetonitrile(A):water(B) containing 0.1% TFA and the sample was eluted using the following gradient: 20% B for 2 min, 20-40% B over 20 min, and 95% B for 3 min. The flow rate was 80 mL/min. Fractions containing rebaudioside F were pooled and solvent evaporated to give 3 g of material comprising about 15% to 22% rebaudioside F.

The material comprising about 15% to 22% rebaudioside F was then dissolved in H₂O, and 30 mg aliquots were injected, and separated, by semi-prep-HPLC (semi-preparative-HPLC, Gilson 281, chromatography column ODS (Luna C18 100×30.0 mm, 5 μm)). The mobile phase was acetonitrile(A):water(B) containing 0.1% TFA and the sample was eluted using the following gradient: 15-35% B over 11 min, 35% B for 2 min, and 100% B for 2 min. The flow rate was 25 mL/min. This procedure resulted in material comprising about 75% to 90% pure rebaudioside F.

In a final purification step, the material comprising about 75% to 90% rebaudioside F was dissolved in H₂O and subjected to semi-prep-HPLC ((semi-preparative-HPLC, Gilson 281, chromatography column ODS (Luna C18 100×30.0 mm, 5 μm)) using acetonitrile(A):water(B) containing 0.1% TFA and the sample was eluted using the following gradient: 15-35% B over 11 min, 35% B for 2 min, and 100% B for 2 min. The flow rate was 25 mL/min. Fractions containing rebaudioside F were pooled and solvent evaporated to yield highly pure rebaudioside F (369 mg; ˜92%-98% as determined by UV detection at 210 nm).

### Example 4: Isolation of Rebaudioside F—Method 2

Stevia rebaudiana (TianJin Tianping Biotech Co. Ltd.) extract containing about 0.79% rebaudioside F as determined by UV detection at 210 nm, was dissolved in MeOH and chromatographed by normal phase chromatography via twenty large-scale column runs. For each run, 1.5 kg of stevia extract was adhered onto 2 kg of silica gel and loaded on top of a normal phase column (200×200 mm length) packed with an additional 1 kg of 100-200 mesh silica gel. Fractions were eluted using CH₂Cl₂:MeOH:H₂O (100:0:0, 100:9.5:0.5, 100:19:1, 100:47:3, 0:80:20) and 7 L fractions were collected. The fractions were analyzed by LCMS. Fractions containing rebaudioside F were combined and all volatiles were removed under reduced pressure to give about 20 kg of material containing about 0.89% rebaudioside F as determined by UV detection at 210 nm.

5 kg of the material containing about 0.89% rebaudioside F was dissolved in 25 L H₂O, and 250 g samples were subject to prep-HPLC on an MPLC-C18 column chromatography (MPLC Buchi C620, chromatography column ODS (Yamazen ODS-C18 500×80 mm, 40-60 μm)). The mobile phase was acetonitrile(A):water(B) containing 0.1% TFA and the sample was eluted using the following gradient: 20% B for 2 min, 20-100% B over 45 min, 100-100% B for 15 min. The flow rate was 90 mL/min. Fractions containing rebaudioside F were pooled and solvent evaporated to yield 3 kg of crude refined sample containing about 3.61% rebaudioside F.

The crude material was again dissolved in a minimum amount of H₂O, and 50 g samples were injected, and separated by prep-MPLC-C18 column chromatography (MPLC Buchi C620, chromatography column ODS (Yamazen ODS-C18 500×80 mm, 40-60 μm)). The mobile phase was acetonitrile(A):water(B) containing 0.1% TFA and the sample was eluted using the following gradient: 20% B for 2 min, 20-100% B over 45 min, and 100% B for 15 min. The flow rate was 90 mL/min. Fractions containing rebaudioside F were pooled and solvent was removed to yield 2 kg of a further refined sample containing about 4.5% to 6.5% rebaudioside F.

The further refined sample was dissolved in a minimum amount of H₂O, and 1 g sample aliquots were injected, and separated, by prep-HPLC (prep-HPLC, SHIMADZU, chromatography column ODS (Daiso C18 300×50.0 mm, 10 μm)). The mobile phase was Acetonitrile(A):water(B) with 0.1% TFA and the sample was eluted using the following gradient: 20% B for 2 min, 20-35% B over 15 min, 35% B for 5 min, and 95% B for 3 min. The flow rate was 80 mL/min. Fractions containing rebaudioside F were pooled and solvent was evaporated to give 400 g of material containing about 13% to 23% rebaudioside F.

The material comprising about 13% to 23% rebaudioside F was dissolved in H₂O, and 1 g aliquots were injected, and separated, by prep-HPLC (prep-HPLC, SHIMADZU, chromatography column ODS (Daiso C18 300×50.0 mm, 10 μm)). The mobile phase was acetonitrile(A):water(B) with 0.1% TFA and the sample was eluted using the following gradient: 20% B for 2 min, 20-35% B over 15 min, 35% B for 5 min, and 95% B for 3 min. The flow rate was 80 mL/min. Fractions containing rebaudioside F were pooled and solvent was evaporated. This procedure resulted in material comprising about 50% to 70% rebaudioside F.

In a final purification step, the material comprising about 50% to 70% rebaudioside F was dissolved in H₂O, and 200 mg aliquots were injected, and separated, by prep-HPLC (prep-HPLC, SHIMADZU, chromatography column ODS (Daiso C18 300×50.0 mm, 10 μm)). The mobile phase was acetonitrile(A):water(B) with 0.1% TFA and the sample was eluted using the following gradient: 20% B for 2 min, 20-35% B over 15 min, 35% B for 5 min, and 95% B for 3 min. The flow rate was 80 mL/min. Fractions containing rebaudioside F were pooled and solvent was evaporated to yield high-purity rebaudioside F (90-98%; as determined by UV detection at 210 nm).

1-33. (canceled)

34. A method of enhancing the sweetness of a sweetener, the method comprising combining the sweetener with about 35 ppm to about 150 ppm of rebaudioside F, wherein the sweetener is a nutritive or non-nutritive sweetener.

35. The method of claim 34, wherein the sweetener is a nutritive or non-nutritive sweetener other than a steviol glycoside.

36. The method of claim 35, wherein the sweetener is selected from the group consisting of high fructose corn syrup (HFCS), fructose, glucose, sucralose, aspartame, sucrose, and combinations thereof.

37. The method of claim 36, wherein the effective amount of rebaudioside F ranges from about 60 ppm to about 150 ppm.

38. The method of claim 36, wherein the effective amount of rebaudioside F ranges from about 35 ppm to about 90 ppm.

39. The method of claim 38, wherein the effective amount of rebaudioside F is about 60 ppm.

40. The method of claim 38, wherein the effective amount of rebaudioside F is about 90 ppm.

41. A beverage, the beverage comprising:
water;
a sweetener; and
about 35 ppm to about 150 ppm of rebaudioside F.

42. The beverage of claim 41, wherein the sweetener is a nutritive or non-nutritive sweetener.

43. The beverage of claim 42, wherein the sweetener is a nutritive or non-nutritive sweetener other than a steviol glycoside.

44. The beverage of claim 41, wherein the effective amount of rebaudioside F ranges from about 60 ppm to about 150 ppm.

45. The beverage of claim 41, wherein the effective amount of rebaudioside F ranges from about 60 ppm to about 90 ppm.

46. The beverage of claim 45, wherein the effective amount of rebaudioside F is about 60 ppm.

47. The beverage of claim 45, wherein the effective amount of rebaudioside F is about 90 ppm.

48. The beverage of claim 41, wherein the beverage is a coffee drink, a cola drink, a tea drink, a juice drink, a dairy drink, a sports drink, a ready-to-drink drink, a fountain drink, a frozen drink, a frozen carbonated drink, a carbonated drink, an energy drink, or a flavored water drink.

49. A beverage syrup, the beverage syrup comprising:
water;
a sweetener; and
rebaudioside F at a concentration ranging from about 210 ppm to about 900 ppm.

50. The beverage syrup of claim 49, wherein the sweetener is a nutritive sweetener or a non-nutritive sweetener other than rebaudioside A.

51. The beverage syrup of claim 50, wherein the nutritive sweetener or non-nutritive sweetener is selected from the group consisting of high fructose corn syrup (HFCS), fructose, glucose, sucralose, aspartame, sucrose, and combinations thereof.

52. The beverage syrup of claim 49, wherein the rebaudioside F concentration ranges from about 360 ppm to about 900 ppm.

53. The beverage syrup of claim 49, wherein the rebaudioside F concentration is about 180 ppm, about 360 ppm, or about 540 ppm.
